(19) United States
(12) Patent Application Publication
(10) Pub. No.: US 2012/0279380 A1
(43) Pub. Date: Nov. 8, 2012

(54) FREQUENCY TUNING DEVICE, SYSTEM, AND METHOD OF USE THEREOF

(76) Inventors: Jonathan Daniel Ashdown, Greenwich, NY (US); Arthur Charles Depoian, Williamsville, NY (US)

(21) Appl. No.: 13/102,754

(22) Filed: May 6, 2011

(51) Int. Cl. G10G 7/02

(52) U.S. Cl. 84/454

(57) ABSTRACT

A frequency tuning device comprising an actuator configured to receive one or more adapters, the one or more adapters adapted to engage a tuning member, and a processing unit, the processing unit in communication with the actuator, wherein the processing unit determines an actual frequency to compare with a desired frequency, wherein the actuator receives an electrical signal from the processing unit based on an error signal defined by a difference between the desired frequency and the actual frequency, wherein the actuator moves at least one of the one or more adapters until the actual frequency is approximately equal to the desired frequency. A system comprising a receiving module, a processing module, a comparison module, a drive module, and a torque control module is also provided. Furthermore, an associated method is also provided.

### FIELD OF TECHNOLOGY

The following relates to device, system, and method for frequency tuning and more specifically to embodiments of a device, system, and method of frequency tuning of various musical instruments.

### BACKGROUND

Learning and playing a musical instrument can be very beneficial to the growth of a child, can be relaxing for adults, and may also provide a livelihood for some. A common struggle with various instruments is keeping the instrument in tune. An instrument is out of tune when a pitch/tone is either too high or too low in relation to a given reference pitch. To tune the instrument, the user must adjust the pitch of one or more tones from the musical instrument to properly align the intervals between these tones. Typically, the user must manually grip and twist various devices to adjust the tension in the strings of the instrument or adjust a length of an air column in a brass or woodwind instrument, which both require special knowledge and experience to correctly tune the instrument. Properly tuning an instrument can be especially frustrating for a layperson or beginner, and can sometimes deter a beginner from continuing to learn how to play the instrument. Moreover, some instruments are more difficult to tune than others. Thus, a need exists for a device which may tune an instrument for the user, which does not require specialized knowledge.

Further, a need exists for a frequency tuning device and method that can quickly tune one or more instruments in real-time, without the complications associated with current tuning methods.

### SUMMARY

A first general aspect relates to a frequency tuning device comprising an actuator configured to receive one or more adapters, the one or more adapters adapted to engage a tuning member, and a processing unit, the processing unit in communication with the actuator, wherein the processing unit determines an actual frequency to compare with a desired frequency, wherein the actuator receives an electrical signal from the processing unit based on an error signal defined by a difference between the desired frequency and the actual frequency, wherein the actuator moves at least one of the one or more adapters until the actual frequency is approximately equal to the desired frequency.

A second general aspect relates to a system comprising a receiving module for receiving an audio signal from a device, a processing module for determining an actual frequency of the audio signal of the device, a comparison module for comparing the actual frequency with a desired frequency to determine an error signal, a drive module for sending an electrical signal based on a value of the error signal to an actuator to operably rotate an adapter removably connected to an end of the actuator, and a torque control module for controlling an amount of mechanical torque output by the actuator by monitoring and controlling the current of the electrical signal supplied to the actuator.

A third general aspect relates to a method of frequency tuning comprising receiving an audio signal for signal processing, determining an actual frequency of the received audio signal, comparing the actual frequency with a desired frequency, detecting an error signal, the error signal having a value defined by the difference between the desired frequency and the actual frequency, transmitting an electrical signal to an actuator, wherein the actuator is configured to operably rotate an adapter, and monitoring at least one parameter of the electrical signal applied to the actuator to ensure a desired output of the actuator.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a schematic view of an embodiment of a system;

FIG. 2 depicts a perspective view of an embodiment of an instrument, and an embodiment of a device for tuning the frequency of the instrument;

FIG. 3 depicts an embodiment of a system that is used with the robotic frequency device, system, and method;

FIG. 4 depicts a flowchart of a first embodiment of a frequency tuning system and method;

FIG. 5 depicts a flowchart of a second embodiment of a frequency tuning system and method;

FIG. 6 depicts a perspective view of an embodiment of an adapter;

FIG. 7 depicts a cross-sectional schematic view of a first embodiment of a frequency tuning device;

FIG. 8 depicts a cross-sectional schematic view of a second embodiment of a frequency tuning device;

FIG. 9 depicts a perspective schematic view of a third embodiment of a frequency tuning device; and

FIG. 10 depicts a schematic view of an embodiment of a computing system

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

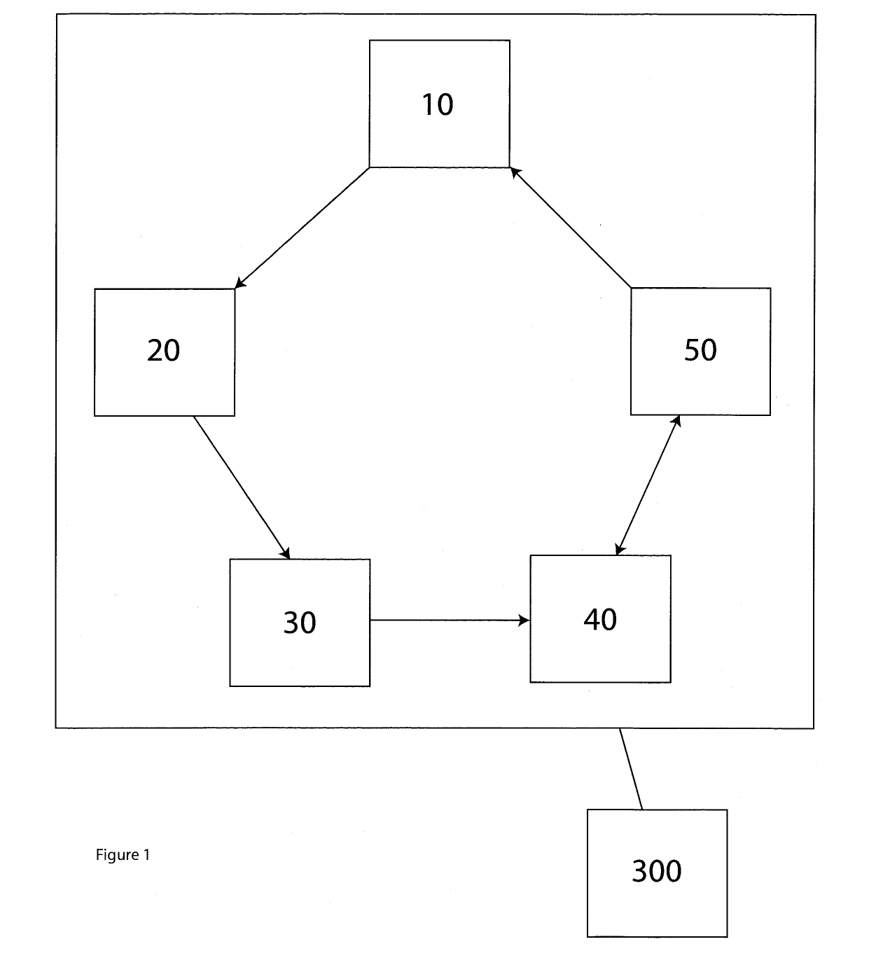

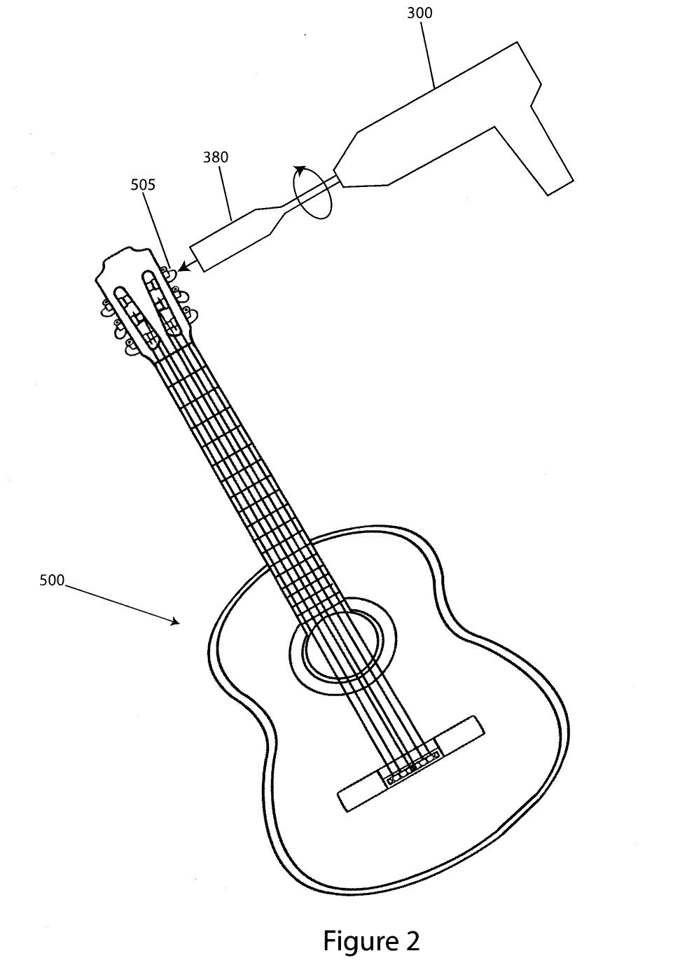

Referring to the drawings, FIG. 1 depicts an embodiment of a system 100. System 100 may include a receiving module 10, a conversion module 20, a processing module 30, a comparison module 40, a drive module 50, and a torque control module 60. Embodiments of system 100 may further include a plurality of adapters 380, described in greater detail below, that are sized and dimensioned to removably engage a wide-variety of tuning members 505 of various instruments 500. Accordingly, embodiments of system 100 and/or device 300 may be used to robotically and modularly tune a frequency of a wide-variety of instruments 500 in real-time using the same or substantially the same hardware/software, and simply placing/re-placing the desired adapter 380 for a particular instrument 500 onto end of device 300. Instrument 500 may be a musical instrument (as shown in FIG. 2), any signal generating device, or any device that requires frequency tuning. For example, instrument 500 may be any device that uses mechanical rotational movement of a tuning member 505 to adjust the tension of one or more strings to adjust the pitch. Accordingly, instrument 500 may be an electric guitar, an acoustic guitar, a piano, a violin, a mandolin, a cello, a bass guitar, a viola, a banjo, and the like.

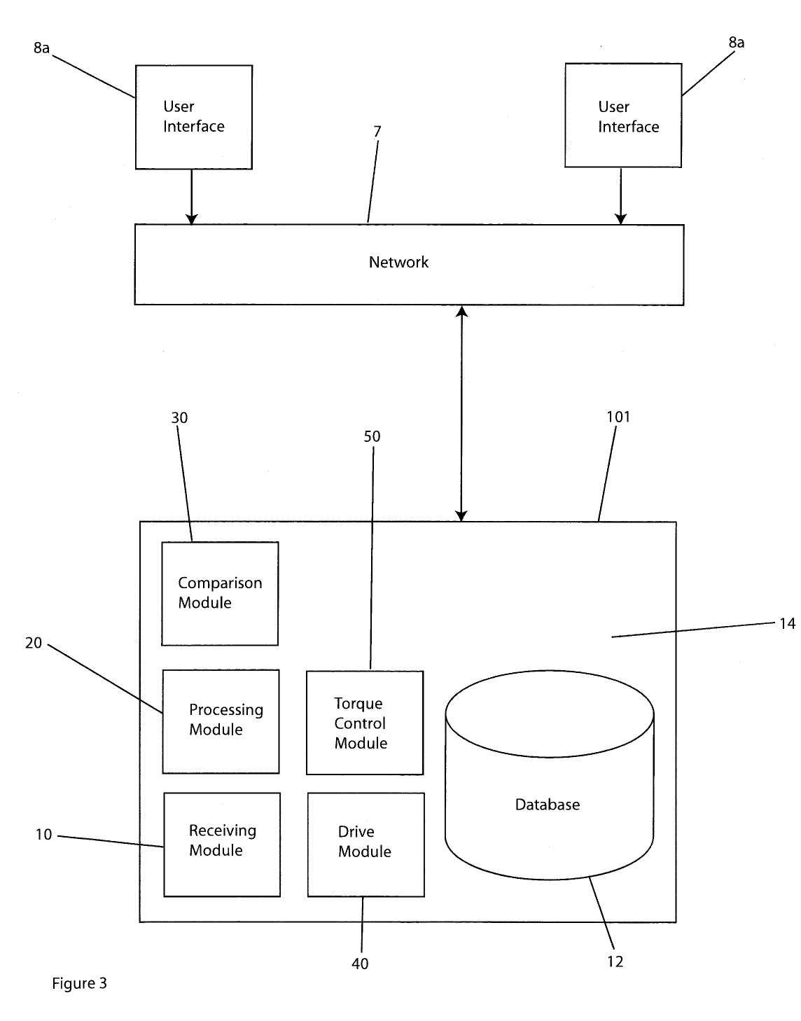

Referring to FIG. 3, an embodiment of system 5 may comprise user interfaces 8a . . . 8n connected through a network 7 to an embodiment of a computing system 101, wherein the computing system 101 includes the receiving module 10, the processing module 20, the comparison module 30, the drive module 40, and the torque control module 50. Network 7 may comprise any type of network including, inter alia, a telephone network, a cellular telephone network, a local area network, (LAN), a wide area network (WAN), the Internet, etc. User interfaces 8a . . . 8n may comprise any type of devices capable of implementing a network (e.g. social network) including, inter alia, a telephone, a cellular telephone, a digital assistant (PDA), a smart phone, a video game system, an audio/video player, a personal computer, a laptop computer, a desktop computer, a computer terminal, etc. Each of user interfaces 8a . . . 8n may comprise a single device or a plurality of devices. User interfaces 8a . . . 8n are used by end users for communicating with each other and computing system 10. For example, users may use the user interfaces 8a . . . 8n to view the sampling of an audio signal by communication with a processor 491. Additionally, users may input data, such as information regarding a desired frequency, or any other data associated with the robotic frequency tuning system, method, and/or device. Furthermore, an embodiment of computing system 101 may be used to implement/execute a robotic frequency tuning system 100, device 300, and method 400. Computing system 101 may comprise any type of computing system(s) including, inter alia, a personal computer (PC), a server computer, a database computer, etc. Computing system 101 may be executing a system 100, steps of method 400, or particular components of device 300. For example, a processor 491 of the computing system 101 may be executing software performing steps/functions associated with the receiving module 10, the processing module 20, the comparison module 30, the drive module 40, and the torque control module 50. Computing system 101 may also connect, wired or wirelessly, to embodiments of device 300 to execute software components/aspects of device 300. Furthermore, computing system 101 may comprise a memory system 14. Memory system 14, or computer readable storage device, may comprise a single memory system. Alternatively, memory system 14 may comprise a plurality of memory systems. Memory system 14 may also comprise a software application and a database 12. Database 12 may include all retrieved, stored, and calculated data associated with a frequency of an incoming/received audio signal, tables/lists of selectable desired frequencies, and any other data required to be stored by database 12. Database 12 may be internal to the computing system 101 and/or memory device 14 as depicted in FIG. 2. Alternatively, database 12 may be external to the computing system 101. Moreover, aspects/components of system 100 may be internal or external to the computing system 101. In one embodiment, the receiving module 10, the processing module 20, the comparison module 30, the drive module 40, and the torque control module 50 may be modules in a software application that can enable a monitoring and distribution method 100. In another embodiment, the receiving module 10, the processing module 20, the comparison module 30, the drive module 40, and the torque control module 50 may be independent software applications or part of the same software application that can enable robotic modular frequency tuning. In yet another embodiment, the receiving module 10, the processing module 20, the comparison module 30, the drive module 40, and the torque control module 50 may each have its own processor in a computing system 101, or may be part of the computing system 101, as shown in FIG. 2.

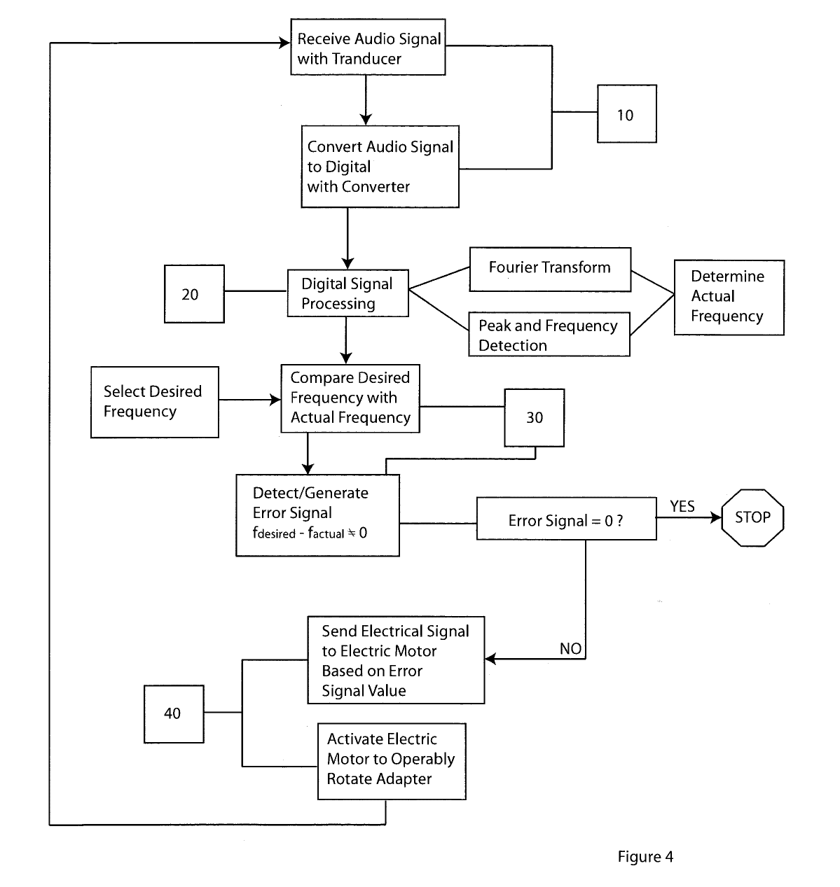

Referring back to FIG. 1, and with additional reference to FIG. 4, embodiments of system 100 may include a receiving module 10 for receiving an audio signal from a device for signal processing. The receiving module 10 may receive an audio signal generated by instrument 500, such an analog or acoustic signal. The receiving module 10 may include a transducer 310, such as a microphone or similar/comparable device. For instance, when a user plays/strikes a string, chord, key, etc., of instrument 500 to generate an audio signal, the transducer, such as a microphone, receives the audio signal for signal processing. The transducer 310 may be positioned with the housing unit 305 of the device 300, or may be positioned external to the housing unit 305. For example, the transducer 310, or microphone, may be built into a user computer, wherein the user computer is in communication with the processing module 20, or other components of system 100 and/or device 300. The received audio signal's fundamental frequency may be determined by the processing module 20. Furthermore, the transducer 310 of the receiving module 10 may convert the received audio signal (e.g. acoustic signal) to a digital signal. For example, the receiving module 10 may convert an analog signal to a digital signal, and/or may convert an acoustic signal to an electrical signal for signal processing by the processing module 20 which is coupled to the receiving module 10. The transducer in its broadest sense means a device that converts one type of energy to another. In this case, the transducer 310 is an electroacoustic device such as a pickup, humbucker, microphone, tactile transducer, piezoelectric crystal, gramophone or gramophone pickup, laser, etc. or any device which captures acoustic waves and converts them to an electrical signal, such as an analog electrical voltage signal. This analog electrical voltage signal may then be sampled which results in a digital signal which may then be processed.

Embodiments of system 100 may include a processing module 20. Embodiments of the processing module 10 may be software, code, algorithms, or similar application(s) executed by a processor 491 of computing system 101, wherein the processing module 20 may include/run a pitch detection algorithm and a fundamental frequency detection algorithm. Furthermore, the processing module 20 of system 100 may determine a fundamental frequency and associated overtones by using a combination of peak and pitch detection algorithms which detect a magnitude and a frequency of the signal, including the fundamental frequency and associated overtones. For instance, the processing module 20 may determine the fundamental frequency by observing a lowest frequency peak that has at least three corresponding harmonics as determined by an overtone series.

Embodiments of the processing module 20 may sample and process the received audio signal into a digital representation using a fast Fourier Transform (FFT) to analyze the frequency content of the signal. Accordingly, the processing module 20 may sample the analog or acoustic signal received by the transducer 310/receiving module 10. In other words, the processing module 20 can extract samples from a continuous signal to create a discrete signal (or discrete-time-signal). The pitch detection of processing module 20 may also use a Discrete Fourier Transform (DFT) to access the frequency domain representation of a sampled note. The DFT can be used because it can be calculated efficiently using Fast Fourier Transform, and because the sampled notes are a periodic signal. In one embodiment, the fft( ) function of Matlab is used to generate the DFT. One method used to find peaks can be differentiation of the discrete signal, followed by zero-crossing detection. This method can find all of the corners, points where the derivative is discontinuous. For example, upward zero-crossings of a function f, defined as a point p, where f(p)=0, and f(p+1)=0, mark valleys, and downwards zero-crossings, where f(p)=0, and f(p+1)=0, indicate peaks in the original signal. Moreover, pre-filtering can be applied to the raw frequency spectrum generated by the FFT to eliminate some of the small peaks that occur due to noise. Embodiments of the processing module 20 may use a Matlab command smooth( ) which is moving average smoothing filter. This step can eliminate much of the small transient peaks that are present due to noise. The remaining noise can be removed by post detection processing. Accordingly, peak detection can applied to the frequency spectrum of the sample to find the most prominent frequencies of the note. The peaks are stored in a Boolean parallel array the same length as the frequency spectrum, with ‘1’ signifying the presence of a peak.

Because a detected peak list can be full of extraneous peaks, the processing module 20 may need to clear those out, leaving the most significant peaks that accurately represent the frequency of the note. The first step in the peak winnowing process may be the use of an absolute threshold. The absolute threshold may be a magnitude value below which any lesser peak is removed, overwritten in the peaks array, for example, by a ‘0’. The absolute threshold can be calculated from the magnitude of the highest peak in the sample. In one embodiment, a factor of 0.015 is applied to get the threshold, so that every peak less than 1.5 percent of the tallest one is removed. Low frequencies below 200 Hz can be biased by increasing their magnitude to offset a poor low frequency response of, for example, a headset microphone. The biasing can be controlled by a low bias factor variable.

Furthermore, the processing module 20 can determine the relative height of the representative peaks. For instance, the absolute threshold test may let through some extraneous peaks that are between two high valleys. This exemplary algorithm can calculate a relative height value for each peak based on the height of the peak, subtracting the averaged values of the two adjacent valleys. In one embodiment, a threshold value is set at 2 percent of the value of the highest peak, and peaks with a lower relative height are eliminated. Another elimination method that may be used is a neighbor elimination method that finds all peaks within a certain distance and eliminates all but the tallest one. Embodiments of the processing module 10 may look for peaks spaced apart a certain distance, at multiples of the fundamental frequency. The neighbor elimination method may also rely on the fact that the overtone frequencies can have the tallest peaks in the spectrum. For example, if the leftmost (lowest frequency) peak found is the fundamental frequency, then applying neighbor elimination with the distance slightly smaller than the position of the first peaks can eliminate all the extraneous peaks from the spectrum. In one embodiment, if the neighbor distance is set as 0.95*index(1), the position of the leftmost peak may be detected if the position of the tallest peak is more than twice as great as the position of the leftmost peak. In another embodiment, the distance is set to 0.045* and 0.95 to ensure that the algorithm will not try to eliminate the harmonics against each other.

Referring still to FIGS. 1 and 4, embodiments of the processing module 20 may determine a fundamental frequency and any associated harmonics/overtones to determine an actual frequency using a fundamental frequency detection algorithm. The actual frequency can be the fundamental frequency plus the harmonics (overtones); the actual frequency may be the actual note of the instrument 500 being played by the user. The processing module 20 may perform a Fourier transform to analyze the digital signal in the frequency domain, as opposed to the time domain of the received audio signal generated by the instrument 500. Determining the fundamental frequency and the harmonic overtones can involve counting harmonics, wherein the harmonics are multiples (e.g. first harmonic, second harmonic, third harmonic, etc.) of the fundamental frequency. For instance, the first harmonic can be the fundamental frequency, the second harmonic can be twice the frequency, and the third harmonic can be triple the frequency. Alternatively, the second harmonic can be the first overtone, and the third harmonic can be the second overtone, wherein the first harmonic is the fundamental frequency. Moreover, the resulting list of peaks can be passed through to the fundamental frequency detection algorithm. The fundamental frequency detection algorithm may take a given peak, starting with the lowest frequency peak, and compare frequency ratios between the peak, and each higher frequency peak. Each whole number ratio found can be counted as a harmonic. Because the algorithm starts at the lowest frequency peak and works its way up, the fundamental frequency can be found at the lowest frequency that has 3 or more harmonics, the first such peaks found can be the fundamental frequency. In some embodiments, a 5 percent error margin can be used to take into account peaks that do not lie exactly on a whole-number ratio.

Referring again to FIG. 1 and FIG. 4, embodiments of system 100 may further include a comparison module 30. Embodiments of the comparison module 30 may, in real-time, compare the actual frequency determined by the processing module 20 with a selected or a desired frequency. The desired frequency may be a frequency desired by a user for a particular note of an instrument 500 or a particular frequency of a string, chord, key, etc., of an instrument 500. A table or list of desired frequencies may be stored in a database 12 of computing system 101 and may be selected by the user at the beginning of the tuning process. Alternatively, the comparison module 30 may suggest a desired frequency to the user. Once the processing module 20 determines the actual frequency, the comparison module 30 may compare the desired frequency with the actual frequency to determine a difference in the frequencies. The difference in the frequencies may define an error signal having a certain value. For instance, the comparison module 30 may determine the value of the desired frequency subtracted by the actual frequency (error signal=f_{desired}−f_{actual}). In other words, the comparison module 30 may detect an error signal, or a value of the error signal. After or simultaneous with detecting an error signal, if the error signal has a value, that is, if the difference between the desired frequency and the actual frequency is a value other than zero (or approximately zero, such as 0.01 Hz to 0.1 Hz), the comparison module 30 may communicate with the drive module 40 to actuate an actuator 340 to operably rotate an adapter 380 to rotate a tuning member 505 of an instrument 500. For example, the comparison module 30 may communicate with the drive module 40 to send an electrical signal (i.e. current) to operate the actuator 340. The electrical signal supplied to the actuator 340 may continue to supplied by the drive module 40 until end the error signal reaches zero (or approximately zero), and the comparison module 30 communicates/notifies the drive module 40. Thus, embodiments of system 100 may include a continuous operation of the actuator 340 and ultimately continuous rotation/operation of the tuning member 505 on the instrument 500 until the comparison module 30 detects an error signal having no value, or a value close to zero and communicates with the drive module 40. When the comparison module 30 communicates to the drive module 40 that the actual frequency is equivalent or approximately equivalent to the desired frequency (note in tune), the drive module 40 may stop sending the electrical signal to the actuator 340, and the actuator may shut off, and cease mechanically rotating the armature 345, which in turn, stops the rotation of the tuning member 505 of the instrument. As described infra, embodiments of system 100 and/or device 300 may include an indicator to alert a user that the instrument 500 has been accurately tuned.

Embodiments of the system 100 may also include a drive module 40 coupled to and/or in communication with the comparison module 30. The drive module 40 may implement a motor control algorithm that can be a proportional closed-loop control. The drive module 40 may receive information from the comparison module 30 to actuate an actuator because the difference between the desired frequency and the actual frequency (i.e. error signal) is not zero or approximately zero. For example, once the fundamental frequency is determined, an error value may be generated, and the error signal (having a value) may be used to calculate a direction of rotation of an actuator 340 which can interface with a tuning member 505 to likewise turn the tuning member 505 to the desired tone of the instrument 500. Embodiments of the drive module 40 may control/operate an actuator 340 and a drive. The drive can include the parts/components transmitting the mechanical force(s) from an armature 345 to an adapter 380. The actuator 340 can be a system including the armature 345 and the magnetic field generators, magnetic field reversing controls, servo controls, brushes, etc. Those skilled in the art should appreciate that the actuator may not include brushes if a brushless motor is employed. Embodiments of the actuator 340 may be an actuator that may be provide mechanical rotation of the armature 345. Embodiments of the actuator 340 may be a stepper motor, a geared motor, or any motor/device that converts electrical energy into mechanical energy. In one embodiment, a stepper motor having a resolution of 1.9 degree step may be used. In another embodiment, a geared motor may be used to obtain more torque and rotational velocity. In its broadest sense, an actuator means a mechanical device for moving or controlling a tuning device on an instrument. The actuator may be directly controlled by an electric signal, or indirectly controlled by an electric signal through hydraulic or pneumatic pressure. Examples of actuators include: electric motor, pneumatic actuator, hydraulic actuator, linear actuator, and piezoelectric actuator. In another embodiment, the actuator 340 may be a linear motor to produce linear mechanical movement. For example, a tuning member 505 of an instrument 500 may require axial, translational, or simply linear movement to tune the instrument 500. For example, a woodwind or brass instrument such as a flute, piccolo, clarinet, trumpet or baritone require a linear movement for tuning. The armature 345 of the actuator 345 is configured to operably rotate (clockwise or counterclockwise) an adapter 380 designed for a particular instrument to alter the frequency. Embodiments of an armature 345 may be a revolving structure of the actuator 340 that can be wound with coils that carry the current supplied by the drive module 40 in response to the comparison module 30. For instance, embodiments of an armature 345 may be a shaft, pole, cylindrical member, and the like, that can extend an axial distance from the electrical motor 340, and can be configured to accept at least one adapter 380. When the actuator 340 cuts-off (electrical current no longer received), or when the device 300 is still be operated (error signal greater than zero detected) an indication may be provided to the user. In one embodiment, the device 300 may include an indicator light, such as an LED light located on the external surface of the housing unit 305 to indicate to the user either that the device 300 is still in operation or further tuning of the instrument 500 is required. In another embodiment, the processor of the computing system 101 executing the modules of system 100 may alert the user through sounds or data messaging to indicate various positions in the tuning process, including the end. In yet another embodiment, a message, such as text, may be provided to a user computer to indicate various positions of the tuning process.

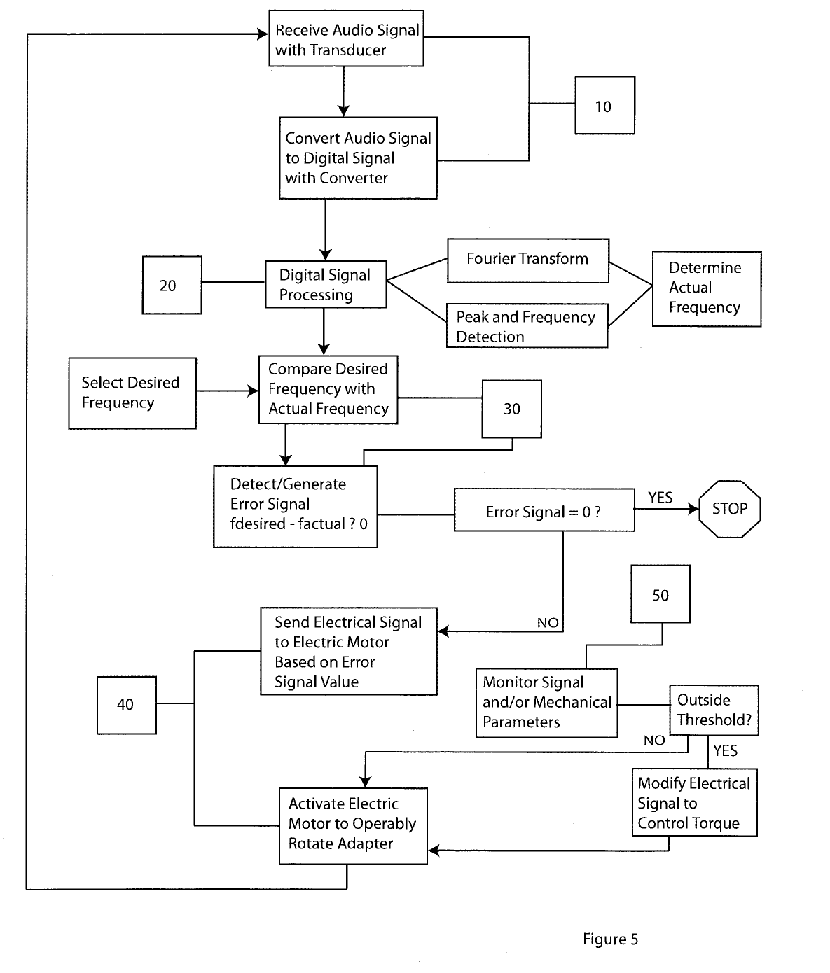

Referring still to FIGS. 1 and 4, and with additional reference to FIG. 5, embodiments of system 100 may include a torque control module 50 for controlling an amount of mechanical torque output by the actuator 340 by monitoring and controlling the current of the electrical signal supplied to the actuator 340. The torque control module 50 may monitor one or more parameters of the electrical signal supplied to the electrical motor 340 and/or parameters of the actuator 340 to ensure that the correct amount of torque is being generated by the actuator 340. Because different instruments 500 require various torque output to twist/rotate the tuning member 505 of the instrument, the torque output of the actuator 340 should be able to be modified in real time to accommodate a wide-variety of instruments 500. For example, the torque requirements to operably rotate a tuning member 505 of a guitar are far less than that to operably rotate a tuning member 505 of a piano. Accordingly, the torque control module 50 may monitor and sense a plurality of electrical parameters of the electrical signal and a plurality of mechanical parameters of the actuator 340, and if the values of the electrical and mechanical parameters exceed an allowable threshold, the torque control module 50 may adjust/modify the electrical signal delivered to the actuator 340 to adjust the torque output of the actuator 340. For instance, a user may set a value and input the threshold value into the computing system 101 executing the torque control module 50, or the software executed by computing system 101 may provide pre-set values that should not be exceeded for a particular instrument 500. If one or more of those values exceed the threshold value, then the torque control module 50 may reduce or increase the current supplied to the actuator 340 to adjust the mechanical output (e.g. torque). In contrast, if none of the threshold values are exceeded, then the torque control module 50 may refrain from modifying the electrical signal supplied to the actuator 340. Examples of electrical and mechanical parameters to be monitored and sensed may include, but are not limited to, the current, the voltage, magnetic flux resistance, impedance, etc., using various measurement instruments such as a voltmeter, torque, angular velocity, revolutions per minute, speed/velocity, etc.

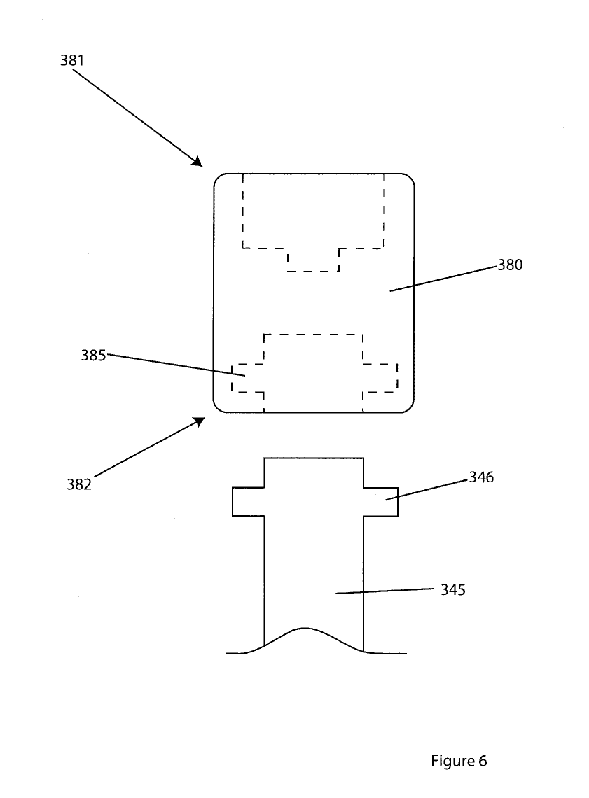

With reference now to FIG. 6, embodiments of system 100 may further include a plurality of adapters 380. Each of the plurality of adapters 380 may be sized and dimensioned to mate with a specific tuning member 505 of a specific instrument 500 at a first end 381, and mate with an end of the actuator 340 (e.g. end of the armature extending from the first end 301 of the device 300). The adapters 380 may be bits, modular bits, modular adapters, and the like, that are configured at a first end 381 to customly mate with a tuning member 505 of a specific instrument 500, and at a second end 382 to mate with an end of actuator 340, or the armature 345 of the actuator 340. The second end 382 of the adapters 380 may have an inner surface shape that can removably yet securably engage an end of the armature 345 of the actuator 340 such that the adapter 380 rotates with the rotation of the armature 345. The removably secure engagement between the adapter 380 and the actuator 340 may rely simply on a snug interference fit there between, or may have internal detents 385 that accept retractable protrusions 346 positioned proximate an end of the armature 345 to provide sufficient engagement. For instance, as the adapter 380 is slid onto the end of the armature 345, the inner surface proximate the second 382 may initially depress the retractable protrusions 346, and as the adapter 380 is advanced further onto the armature 345, the retractable protrusions 346 can outwardly expand into a secure fit within the internal detents 385. Those having skill in the requisite art should appreciate that various mechanical means and methods to secure the adapter to an end of the armature 345 may be used to facilitate a removably secure connection. For example, embodiments of the adapter 380 may further include a one inch socket head for attaching to a socket head connected to the end of the armature 345 to allow for adaptation to already manufactured socket sets for use on instruments that utilize standard heads. Thus, each of the adapters 380, proximate the second end 382, may have the same or substantially the same internal shape to mate with the armature 345 of the actuator 340, wherein the internal shape may vary to match a the size, thickness, circumference, etc. of the armature 345 of the motor 340.

Furthermore, each of the adapters 380 may have a different external and/or internal shape proximate the first end 381 of the adapter to accommodate a size, shape, design, etc. of a tuning member 505 of an instrument 500. In other words, the adapter 380 should translate rotational movement to the tuning member 505 of the instrument when the armature 345 of the actuator is rotating/actuated. For example, a first adapter 380 may have an external and internal shape/design proximate the first end 381 to mate with a tuning peg of a guitar, a second adapter 380 may have an external and internal shape/design proximate the first end 381 to mate with a tuning peg of a violin, a third adapter 380 may have an external and internal shape/design proximate the first end 381 to mate with a tuning peg of a mandolin, and a fourth adapter 380 may have an external and internal shape/design proximate the first end 381 to mate with a tuning peg of a piano. Those skilled in the art should appreciate that there are many other adapters that can be designed to mate with various instruments that are not explicitly discussed herein, but are nonetheless could be embodied by the adapter 380. Because the first end 381 of the adapters 380 may be sized and dimensioned to accommodate any tuning member 505 of a wide-variety of instruments 500, and the second end 382 of the adapters 380 may be sized and dimensioned to mate with the armature 345 of the actuator 340, device 300 in combination with system 100 may be a modular system that allows for the attachment and removal of various adapters 380 to tune a wide-variety of instruments with the same system 100 and/or device 300.

Embodiments of the adapters 380 may be attached and detached to the armature 345 of the motor 340 with relative ease, and can allow for quick testing of one or more different instruments 500 before heading onto stage. Embodiments of the adapter 380 may be made of plastics, composites, metals or a combination thereof. For instance, the adapters 380 may be constructed from polyvinyl chloride (PVC) pipe sections that can be glued into each other with machining done previous to the gluing. The adapters 380 may be constructed to grab a tuning member 505, such as a tuning peg, and a solid centered grip to allow for accurate tuning. Moreover, embodiments of the various adapters 380, while being sized and dimensioned differently, may also be constructed out of different materials to accommodate various tuning members 505 of instruments. For example, embodiments of the adapters may be PVC or rigid PVC having a tensile strength of approximately 28.4 MPa and a modulus of elasticity of approximately 2.45 GPa with a Rockwell hardness of approximately 107, which may work better for instruments such as a guitar, violin, mandolin, and the like. Other embodiments of the adapters 380 may be constructed out of a metal or metal alloy, such as a chrome vanadium steel (e.g. AISI 6150), having a tensile strength of approximately 615 MPa and a modulus of elasticity of approximately 205 GPa with a Rockwell hardness of approximately 27, which may work better for instruments requiring more torque to operate/rotate the tuning member, such as a piano.

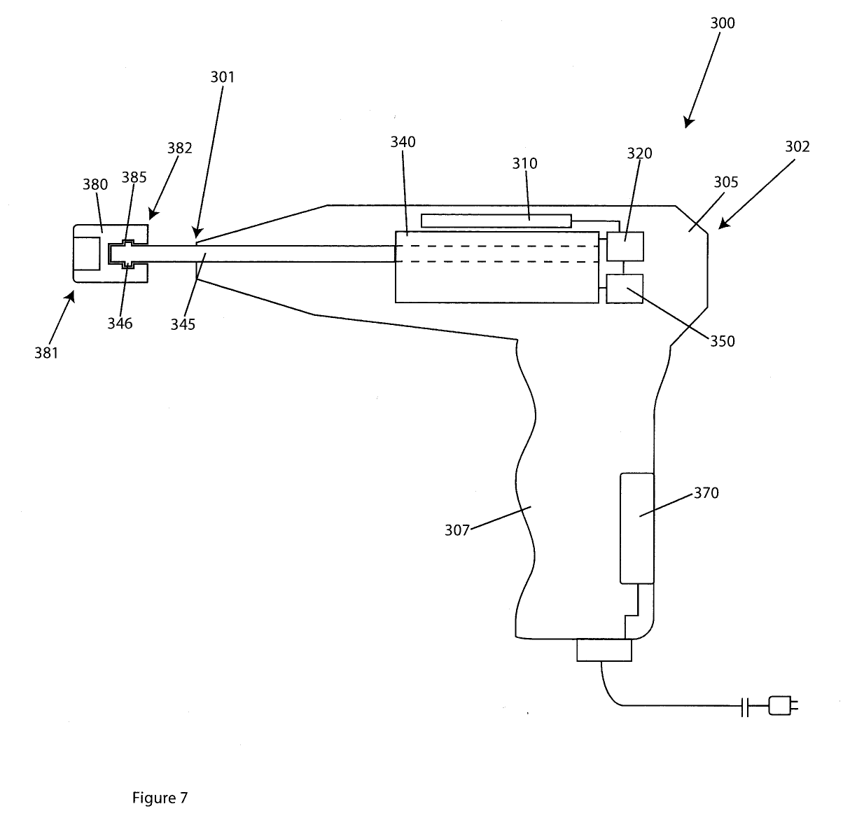

Referring now to FIGS. 7-9, embodiments of a device 300 is now described in further detail. Embodiments of device 300 may include a housing unit 305 having a first end 301 and a second end 301, an actuator 340 housed within the housing unit 305, wherein an armature 345 of the actuator 340 extends a distance from the housing unit 305 proximate the first end 301, the armature 345 configured to receive at least one of a plurality of adapters 380, a processing unit 320, the processing unit 320 in communication with the actuator 340, wherein the processing unit 320 determines an actual frequency to compare with a desired frequency, wherein the actuator 340 within the housing unit 305 receives an electrical signal from the processing unit 320 based on an error signal defined by a difference between the desired frequency and the actual frequency. Embodiments of the device 300 may further include a torque controller 350 disposed within the housing unit 305, the torque controller 350 controlling an amount of torque generated by the actuator 350, a transducer 310 disposed within the housing unit to receive an audio signal from the instrument and convert the audio signal into a digital signal to process in the frequency domain, and a power unit 370 configured to provide a source of power to the device. Embodiments of the processing unit 320 may share the same function as the processing module 20, but may be a hardware component, such as a processor chip, capable of executing the steps associated with the processing module 20, comparison module 30, and/or drive module 40, such as sending an electrical signal to the actuator 340. Likewise, embodiments of the transducer 310 may share the same function as the receiving module 10, but may be a hardware component, such as a microphone, disposed externally or internally of the housing unit 305. Embodiments of the torque controller 350 may share the same function as the torque control module 50, but may also include a hardware component(s) capable of executing the steps associated with the torque control module 50. Embodiments of the power unit 370 may be located within the outer house or externally mounted to the outer housing unit 305. The power unit 370 may be one or more batteries, such as primary or secondary rechargeable batteries, lithium ion batteries. Further embodiments of the power unit 370 may be operable with main power supplies.

Energy scavenging and/or power harvesting techniques could also be employed to convert acoustical vibrations from the instrument into electrical energy which may then be used to power the unit. For instance, the acoustical signal could be converted to an alternating current (AC) electrical signal via a piezoelectric transducer. The resulting AC signal could then be rectified and filtered resulting in a DC signal. The DC signal could then be stored on a capacitor and voltage regulated to act as a constantly replenishable power source for the unit, i.e., converting acoustical vibrations to electrical energy.

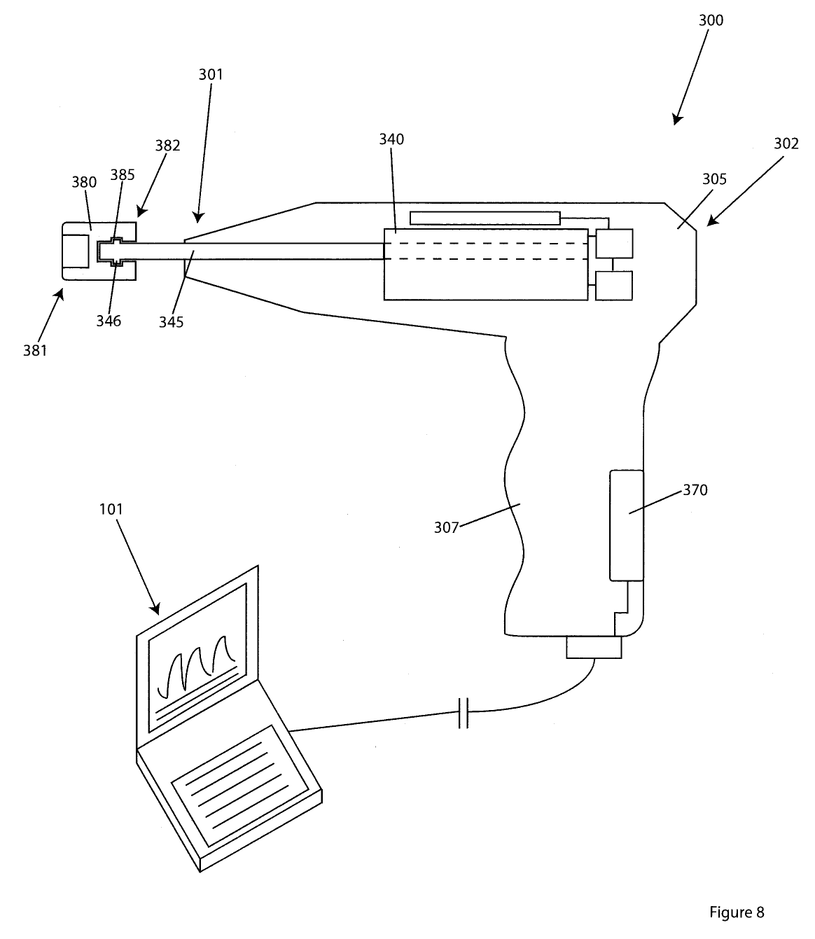

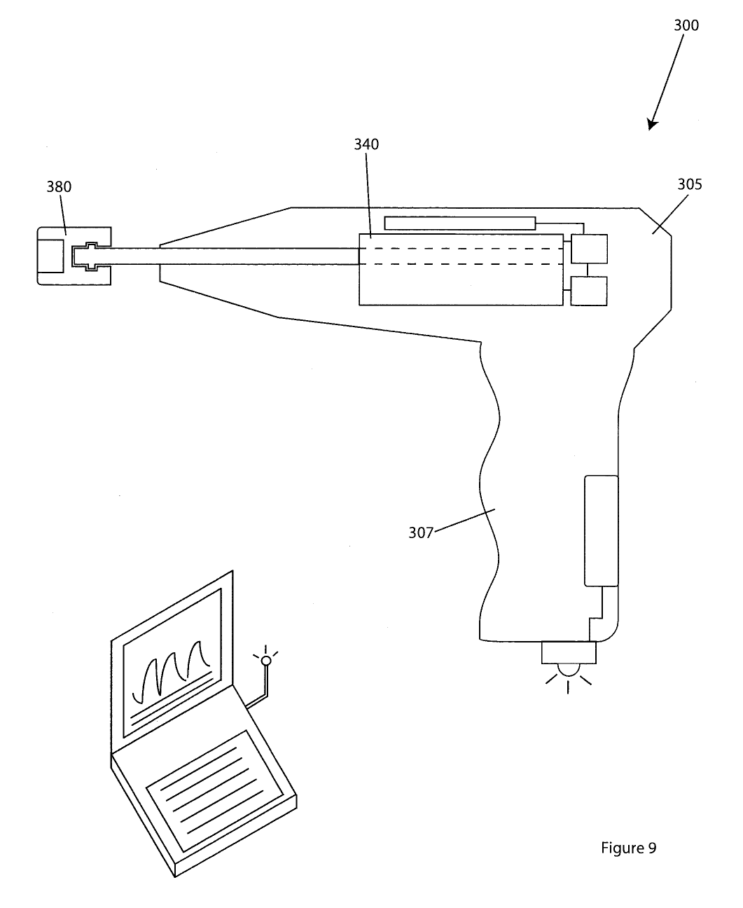

Embodiments of the housing unit 305 may enclose or substantially enclose at least the actuator 340, and potentially other components and computer/processor hardware. The housing unit 305 may be made of plastic, composites, metals, hard plastics, or any material suitable for providing a rigid housing body. The housing unit may include a grip portion 307, such as a pistol grip, to ease the handling of the device 300. However, embodiments of device 300 may not include a grip portion 307. Thus, the device 300 may be a hand-held device. Various indicators may be located on the outer surface of the housing unit 305 to provide a notification to the user, such as a notification that the battery is low. Those skilled in the art should appreciate that buttons, lights, transparent windows may be utilized on the outer surface of the housing unit 305 to indicate any number of things related to the performance, status, operation, etc. of the device 300. Moreover, system 100 may be embedded in a housing unit 305 (as shown in FIG. 7), or may be external to the housing unit 305, wherein the system 100 is in communication with device 300 (as shown in FIG. 1). For instance, system 100 and the device 300 may communicate through a wired connection (as shown in FIG. 8), or wirelessly (as shown in FIG. 9), including a Bluetooth connection.

Referring to FIGS. 1-9 embodiments of a method of frequency tuning may include the steps of receiving an audio signal for signal processing, determining an actual frequency of the received audio signal, comparing the actual frequency with a desired frequency, detecting an error signal, the error signal having a value defined by the difference between the desired frequency and the actual frequency, transmitting an electrical signal to an actuator 340, wherein the actuator 340 is configured to operably rotate an adapter 380, and monitoring at least one parameter of the electrical signal applied to the actuator 340 to ensure a desired output of the actuator 340. Embodiments of the method of frequency tuning may further include the steps of selecting the desired frequency from a storable list, converting the audio signal into a digital signal, establishing a threshold for the at least one parameter, and modifying the electrical signal if at least one parameter exceeds the threshold of at least one parameter. Embodiments of a method of frequency tuning may include aspects of system 100 and device 300 to robotically and modularly tune a frequency of an instrument 500.

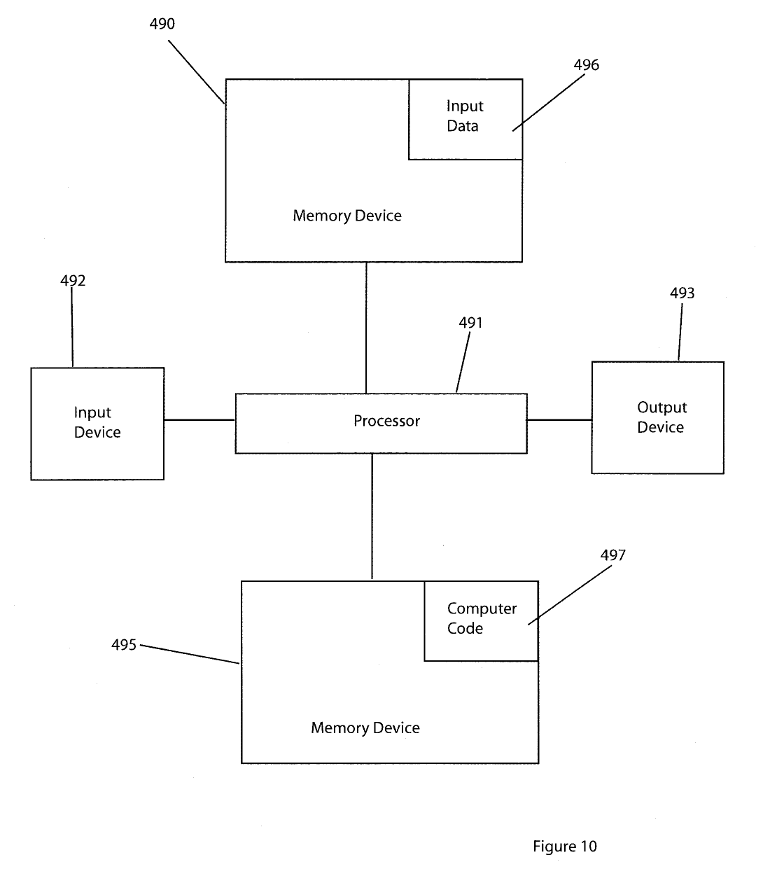

Referring now to FIG. 10, an embodiment of a computer apparatus 490, such as computing system 101 of FIG. 2 used for robotically modularly tuning a frequency of an instrument 500, is now described. The computer system 490 comprises a processor 491, an input device 492 coupled to the processor 491, an output device 493 coupled to the processor 491, and memory devices 494 and 495 each coupled to the processor 491. The processor 491 (of computing system 101) may execute the receiving module 10, the processing module 20, the comparison module 30, the drive module 40, and the torque control module 50, and aspects of device 300. Moreover, the processor 491 may be a single processor executing the receiving module 10, the processing module 20, the comparison module 30, the drive module 40, and the torque control module 50, or may be more than independent processor executing the receiving module 10, the processing module 20, the comparison module 30, the drive module 40, and the torque control module 50. The input device 492 may be, inter alia, a keyboard, a software application, a mouse, etc. The output device 493 may be, inter alia, a printer, a plotter, a computer screen, a magnetic tape, a removable hard disk, a floppy disk, a software application, etc. The memory devices 494 and 495 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 495 includes a computer code 497. The computer code 497 includes algorithms or steps (e.g., the algorithms and/or steps of FIGS. 1-9) for example to detect a peak of a frequency, sample an acoustic signal, counting and analyzing harmonics, etc. The processor 491 executes the computer code 497. The memory device 494 includes input data 496. The input data 496 includes input required by the computer code 497. The output device 493 displays output from the computer code 497. Either or both memory devices 494 and 495 (or one or more additional memory devices not shown in FIG. 3) may comprise the algorithms and/or steps of FIGS. 1-9 and may be used as a computer usable medium (or a computer readable medium or a program storage device) having a computer readable program code embodied therein and/or having other data stored therein, wherein the computer readable program code comprises the computer code 497. Generally, a computer program product (or, alternatively, an article of manufacture) of the computer system 490 may comprise the computer usable medium (or said program storage device). While FIG. 10 shows the computer system 490 as a particular configuration of hardware and software, any configuration of hardware and software, as would be known to a person of ordinary skill in the art, may be utilized for the purposes stated supra in conjunction with the particular computer system 490. For example, the memory devices 494 and 495 may be portions of a single memory device rather than separate memory devices. Therefore, computing system 101 executing the receiving module 10, the processing module 20, the comparison module 30, the drive module 40, and the torque control module 50, can enable a computer-implemented modular frequency system, and associated device 300.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A frequency tuning device comprising:
an actuator configured to receive one or more adapters, the one or more adapters adapted to engage a tuning member; and
a processing unit, the processing unit in communication with the actuator, wherein the processing unit determines an actual frequency to compare with a desired frequency;
wherein the actuator receives an electrical signal from the processing unit based on an error signal defined by a difference between the desired frequency and the actual frequency;
wherein the actuator moves the at least one of the one or more adapters until the actual frequency is approximately equal to the desired frequency.

2. The device of claim 1, wherein the electrical signal is no longer received when the difference between the desired frequency and the actual frequency is zero.

3. The device of claim 1, wherein the actuator is an actuator.

4. The device of claim 1, wherein the processing unit and the actuator are housed within a housing unit.

5. The device of claim 1, wherein the processing unit is external to a housing unit.

6. The device of claim 1, wherein the actual frequency is a fundamental frequency and at least harmonic overtone of an instrument prior to being tuned.

7. The device of claim 1, wherein a first end of each the plurality of adapters is configured to removably connect to the armature of the actuator, and a second end is sized and dimensioned to engage a wide-variety of tuning members of a wide-variety of instruments.

8. The device of claim 1, further comprising:
a torque controller disposed within the housing unit, the torque controller controlling an amount of torque generated by the actuator;
a transducer disposed within the housing unit to receive an audio signal from the instrument and convert the audio signal into a digital signal to process in the frequency domain; and
a power unit configured to provide a source of power to the device.

9. The device of claim 1, wherein the housing unit is a handheld device.

10. A system comprising:
a receiving module for receiving an audio signal from a device;
a processing module for determining an actual frequency of the audio signal of the device;
a comparison module for comparing the actual frequency with a desired frequency to determine an error signal;
a drive module for sending an electrical signal based on a value of the error signal to an actuator to operably rotate an adapter removably connected to an end of the actuator; and
a torque control module for controlling an amount of mechanical torque output by the actuator by monitoring and controlling the current of the electrical signal supplied to the actuator.

11. The system of claim 10, wherein the device is any instrument that requires frequency tuning.

12. The system of claim 10, wherein the actuator is an actuator.

13. The system of claim 10, wherein the error signal is a difference between the desired frequency and the actual frequency.

14. The system of claim 10, wherein the torque control module at least one of reduces and increases the current of the electrical signal supplied to the actuator based on an allowable threshold of at least one parameter of the electrical signal.

15. The system of claim 9, wherein the receiving module converts the audio signal to a digital signal.

16. A method of frequency tuning comprising:
receiving an audio signal for signal processing;
determining an actual frequency of the received audio signal;
comparing the actual frequency with a desired frequency;
detecting an error signal, the error signal having a value defined by the difference between the desired frequency and the actual frequency;
transmitting an electrical signal to an actuator, wherein the actuator is configured to operably rotate an adapter; and
monitoring at least one parameter of the electrical signal applied to the actuator to ensure a desired output of the actuator.

17. The method of claim 14, wherein the adapter is one of a wide-variety of different adapters sized and dimensioned to operably engage a tuning member of a wide-variety of instruments.

18. The method of claim 14, further comprising:
selecting the desired frequency from a storable list;
converting the audio signal into a digital signal;
establishing a threshold for the at least one parameter; and
modifying the electrical signal if the at least one parameter exceeds the threshold of the at least one parameter.

19. The method of claim 14, wherein the method is an iterative process, wherein one or more iteration of the method is carried out until the actual frequency is approximately equal to the desired frequency.

20. The method of claim 14, wherein the actuator is housed within a housing unit.
